(19) United States
(12) Patent Application Publication
(10) Pub. No.: US 2009/0201276 A1
(43) Pub. Date: Aug. 13, 2009

(54) DRIVING METHOD OF A PLASMA DISPLAY DEVICE AND A PLASMA DISPLAY DEVICE

(76) Inventors: Isao Furukawa, Yamato (JP); Yasunobu Hashimoto, Kawasaki (JP); Tomokatsu Kishi, Yokosuka (JP); Katsumi Ito, Yokohama (JP); Takayuki Kobayashi, Fujisawa (JP); Shinsuke Tanaka, Fujisawa (JP); Makoto Ishii, Yokohama (JP); Junichi Kumagai, Yokohama (JP)

Correspondence Address: MCDERMOTT WILL & EMERY LLP, 600 13TH STREET, N.W., WASHINGTON, DC, 20005-3096, US

(21) Appl. No.: 12/277,602

(22) Filed: Nov. 25, 2008

(30) Foreign Application Priority Data
Feb. 8, 2008 (JP) 2008-029570

(51) Int. Cl. G09G 5/00; G09G 3/28

(52) U.S. Cl. 345/208; 345/60

(57) ABSTRACT

At an on-cell reset, a positive ramp wave of an ultimate voltage, which is larger than a maximum voltage of a sustain pulse, and smaller than an ultimate voltage of a positive ramp wave applied to a Y electrode at an all-cell reset, is applied to the Y electrode to make a weak discharge occur at a cell where it is non-lighting at a previous sub-field and a wall charge thereof is decreased due to an influence from an adjacent cell, thereby, it makes it possible to return a wall charge state to a normal state, to be capable of lighting a cell to be lighted securely based on a display data.

### CROSS-REFERENCE TO RELATED APPLICATIONS

This application is based upon and claims the benefit of priority of the prior Japanese Patent Application No. 2008-029570, filed on Feb. 8, 2008, the entire contents of which are incorporated herein by reference.

### BACKGROUND OF THE INVENTION

The present invention relates to a driving method of a plasma display device and a plasma display device.

In a drive of a plasma display panel (PDP), one field is constituted of a plurality of sub-fields, and a gradation expression is realized by selecting at which sub-field a cell is lighted. Each sub-field is constituted of a reset period initializing a wall charge state on an electrode, an address period adjusting the wall charge state based on a display data and performing a selection of a cell to be lighted, and a sustain period lighting the cell corresponding to the display data (the cell selected in accordance with the display data is discharge light emitted).

Further, as discussed in Japanese Laid-open Patent Publication No. 2006-258924, there are an all-cell reset (all cells simultaneous initialization) and an on-cell reset in a reset discharge performed in the reset period. At the all-cell reset, the reset discharge is performed at both of the cells which are lighted and the cells which are not lighted, namely at all cells regardless of whether a sustain discharge is performed or not, in the sustain period of a preceding sub-field. At the on-cell reset, the reset discharge is performed only at the cells which are lighted, namely only at the cells where the sustain discharge is performed, in the sustain period of the preceding sub-field.

### SUMMARY OF THE INVENTION

In a drive of a conventional plasma display panel, an on-cell reset is a reset method of which a wall charge stored by a sustain discharge at a preceding sub-field is decreased so as to make a state where an address discharge occurs easily. At the conventional on-cell reset, the time when the wall charge is decreased at a non-lighting cell in the sustain period of the preceding sub-field has not been considered.

For example, at a sub-field, in the case when a first cell is a non-lighting cell and its both adjacent second and third cells are lighting cells, in an address period, a voltage is applied half to the first cell according to an electric flux line related to the second cell and the third cell as well, which causes a state where as if it is lighting. Consequently, the wall charge to make the address discharge occur is decreased at the first cell, even though it is tried to light the first cell at the following sub-field, the address discharge can not occur, which makes it impossible to light the first cell.

It is an object of the present invention to provide a driving method of a plasma display device capable of lighting a cell to be lighted securely based on a display data.

A driving method of the plasma display device of the present invention, wherein one field is constituted with a plurality of sub-fields, and each sub-field has an address period in which selection of the cell to be lighted is performed in correspondence with the display data and a sustain period in which the cell selected in the address period is made to perform discharge light emission, further each sub-field has a reset period in which a reset discharge initializing a wall charge state on an electrode is performed, wherein the reset period includes a first reset of which the reset discharge is performed at all cells, or a second reset of which the reset discharge is performed at some cells including a lighting cell at a previous sub-field is performed, and when the second reset is performed, a positive second ramp wave of an ultimate voltage, which is larger than a maximum voltage of a sustain pulse applied to a display electrode in the sustain period, and smaller than an ultimate voltage of a positive first ramp wave applied to the display electrode when the first reset is performed, is applied to the display electrode.

The driving method of the plasma display device of the present invention, wherein one field is constituted with a plurality of sub-fields, and each sub-field has an address period in which selection of the cell to be lighted is performed in correspondence with the display data and a sustain period in which the cell selected in the address period is made to perform discharge light emission, further each sub-field has a reset period in which a reset discharge initializing a wall charge state on an electrode is performed, wherein the reset period includes a first reset of which the reset discharge is performed at all cells, or a second reset of which the reset discharge is performed at some cells including a lighting cell at a previous sub-field is performed, and when the second reset is performed, a positive second ramp wave of an ultimate voltage, which is larger than a maximum voltage of a sustain pulse applied to a display electrode in the sustain period, and of which a voltage of a second ramp wave to which the stored wall charge is added is not above a discharge start voltage of between the display electrodes, is applied to the display electrode.

The plasma display device of the present invention, wherein one field is constituted with a plurality of sub-fields, and each sub-field has an address period in which selection of the cell to be lighted is performed in correspondence with the display data and a sustain period in which the cell selected in the address period is made to perform discharge light emission, further each sub-field has a reset period in which a reset discharge initializing a wall charge state on an electrode is performed, the device has a reset unit selecting and performing either a first rest of which the reset discharge is performed at all cells, or a second reset of which the reset discharge is performed at some cells including a lighting cell at a previous sub-field in a reset period, and in which when the second reset is performed, the reset unit applies a positive second ramp wave of an ultimate voltage, which is larger than a maximum voltage of a sustain pulse applied to a display electrode in the sustain period, and smaller than an ultimate voltage of a positive first ramp wave applied to the display electrode when the first reset is performed, to the display electrode.

When the second reset, of which the reset discharge initializing the wall charge state on the electrode is performed at some cells including a lighting cell at the previous sub-field, is performed, the positive second ramp wave of the ultimate voltage, which is larger than the maximum voltage of the sustain pulse and smaller than the ultimate voltage of the first ramp wave at the first reset of which the reset discharge is performed at all cells, is applied, thereby, it is possible to return the wall charge state of the cell, where it is non-lighting at the previous sub-field and a wall charge thereof is decreased due to an influence from the adjacent cell, to a normal state. Consequently, regardless of a display state at the previous sub-field, it is possible to make the address discharge occur securely at the cell to be lighted based on the display data and light the cell at the following sub-field.

### BRIEF DESCRIPTION OF THE DRAWINGS

FIG. 1 is a view depicting a configuration example of a plasma display device according to an embodiment of the present invention;

FIG. 2 is a view depicting a configuration example of a plasma display panel in the present embodiment;

FIG. 3 is a view for explaining an example of a driving method of the plasma display device in the present embodiment;

FIG. 4A and FIG. 4B are views depicting an example of a driving waveform of the plasma display device in the present embodiment;

FIG. 5A and FIG. 5B are views depicting configuration example of a reset circuit in the present embodiment;

FIG. 6 is a view depicting another configuration example of the reset circuit in the present embodiment; and

FIG. 7 is a view depicting another example of a drive waveform in a reset period in the present embodiment.

### DETAILED DESCRIPTION OF THE PREFERRED EMBODIMENTS

Hereinafter, embodiments of the present invention are described based on the drawings.

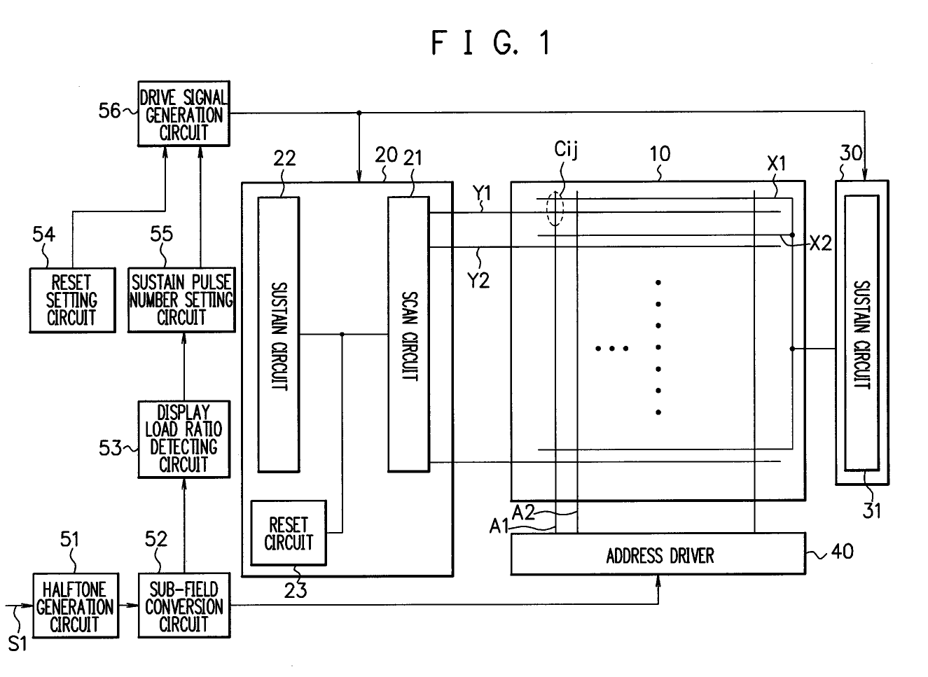

FIG. 1 is a block diagram depicting a configuration example of a plasma display device according to an embodiment of the present invention. The plasma display device in the present embodiment has a plasma display panel 10, a Y electrode driver 20, an X electrode driver 30, an address driver 40, a halftone generation circuit 51, a sub-field conversion circuit 52, a display load ratio detecting circuit 53, a reset setting circuit 54, a sustain pulse number setting circuit 55, and a drive signal generation circuit 56.

The Y electrode driver 20 is a circuit driving Y electrodes (scan electrodes) Y1, Y2, and so on among display electrodes. The Y electrode driver 20 has a scan circuit 21, a sustain circuit 22, and a reset circuit 23. Hereinafter, each of the Y electrodes Y1, Y2, and so on or their generic name is referred to as a Y electrode Yi, i representing a subscript.

The scan circuit 21 is configured with circuits selecting a row to be displayed by performing a line-sequential scanning. The sustain circuit 22 is configured with circuits repeating a sustain discharge. The reset circuit 23 is configured with circuits initializing a wall charge state. A predetermined voltage is supplied to the plural Y electrodes Yi by the scan circuit 21, the sustain circuit 22, and the reset circuit 23.

In the scan circuit 21, a plurality of switches corresponding to the Y electrodes Y1, Y2, and so on respectively are provided. The scan circuit 21 operates such that a reset voltage from the reset circuit 23 is applied to all the Y electrodes Y1, Y2, and so on simultaneously in a reset period, and a scan pulse is applied to the Y electrodes Y1, Y2, and so on sequentially in an address period, and a sustain pulse (a sustain discharge pulse) from the sustain circuit 22 is applied to all the Y electrodes Y1, Y2, and so on simultaneously in a sustain period.

The X electrode driver 30 is a circuit driving X electrodes (sustain electrodes) X1, X2, and so on among the display electrodes. The X electrode driver 30 has a sustain circuit 31. Hereinafter, each of the X electrodes X1, X2, and so on or their generic name is referred to as an X electrode Xi, i representing a subscript. The sustain circuit 31 is configured with circuits repeating the sustain discharge, and supplies a predetermined voltage to the X electrode Xi. One end of the X electrode Xi is common-connected to the X electrode driver 30.

The address driver 40 is configured with circuits selecting a column to be displayed, and supplies a predetermined voltage to plural address electrodes A1, A2, and so on. Hereinafter, each of the address electrodes A1, A2, and so on or their generic name is referred to as an address electrode Aj, j representing a subscript.

An image signal S1 in a digital format is input to the halftone generation circuit 51. The halftone generation circuit 51 generates a halftone by performing an error diffusion process, a dither process, and the like in order to display the image signal S1 with limited lighting patterns. The sub-field conversion circuit 52 selects a lighting pattern of a sub-field based on the image signal output from the halftone generation circuit 51, and converts the image signal into the lighting pattern corresponding thereto. Depending on the lighting pattern output from the sub-field conversion circuit 52, the address driver 40 generates a voltage to apply to the address electrode Aj to select the sub-field to be lighted regarding each pixel.

The display load ratio detecting circuit 53 calculates a display load ratio of every field based on the lighting pattern output from the sub-field conversion circuit 52. The display load ratio is detected based on the number of pixels to emit light and a gradation value of the pixel to emit light. For example, in the case when all pixels of an image are displayed at a maximum gradation value, the display load ratio is 100%. In the case when all pixels of an image are displayed at a half of the maximum gradation value, the display load ratio is 50%. And further, in the case when only pixels of a half of an image (50%) are displayed at the maximum gradation value as well, the display load ratio is 50%.

The reset setting circuit 54 sets an ultimate voltage of a low voltage reset pulse (a low voltage ramp wave) applied in a performance of an on-cell reset in the reset period based on reset voltage control information supplied from other circuits, and the like. The reset voltage control information is on, for example, the number of the sustain pulses applied in the sustain period of the preceding sub-field, an address width (a width of the scan pulse to be applied) in the address period, an ambient temperature, a cumulative operation time, and so on.

The sustain pulse number setting circuit 55 calculates the total number of the sustain pluses in one field by a constant power control corresponding to the display load ratio detected by the display load ratio detecting circuit 53. Further, the sustain pulse number setting circuit 55 divides the total number of the sustain pulses so as to correspond to the weight ratio among the respective sub-fields, and sets the number of the sustain pulses to apply to each display line at each sub-field in the field.

In the constant power control, the total number of the sustain pulses in one field is controlled according to the display load ratio of one field. Regardless of the display load ratio, when the total number of the sustain pulses in one field is fixed, the larger the display load ratio is, the larger the power becomes, which causes heat quantity to be increased. Therefore, when the display load ratio in one field is large, the constant power control is performed by calculating so as to decrease the total number of the sustain pulses in one field.

The drive signal generation circuit 56 generates a drive signal related to the Y electrode driver 20 and the X electrode driver 30 depending on the outputs from the reset setting circuit 54 and the sustain pulse number setting circuit 55.

In the plasma display panel 10, the Y electrode Yi and the X electrode Xi constituting a display electrode pair form a row extending in parallel in a horizontal direction, and the address electrode Ai forms a column extending in a vertical direction. The Y electrodes Yi and the X electrodes Xi are disposed in the vertical direction alternately. Namely, the Y electrodes Yi and the X electrodes Xi are disposed in parallel each other, and the address electrodes Aj are disposed in approximately the vertical direction to the Y electrodes Yi and the X electrodes Xi. The Y electrode Yi and the address electrode Aj form a two-dimensional matrix with an i row and a j column.

A cell Cij is formed by an intersection of the Y electrode Yi and the address electrode Aj, and the X electrode Xi adjacent corresponding to it. There is a case that a cell is formed by the intersection of the Y electrode Yi and the address electrode Aj, and the X electrode Xi adjacent corresponding to it as well, and a cell is formed by the intersection of the Y electrode Yi and the address electrode Aj, and an X electrode X(i+1) adjacent corresponding to it.

The cell Cij corresponds to sub-pixels of, for example, red, green, and blue, and one pixel is constituted of the sub-pixels of these three colors. The plasma display panel 10 displays an image by lighting a plurality of pixels arranged two-dimensionally. The scan circuit 21 in the Y electrode driver 20 and the address driver 40 determine which cell to light, and the sustain circuit 22 in the Y electrode driver 20 and the sustain circuit 31 in the X electrode driver 30 perform a display operation by performing a discharge repeatedly.

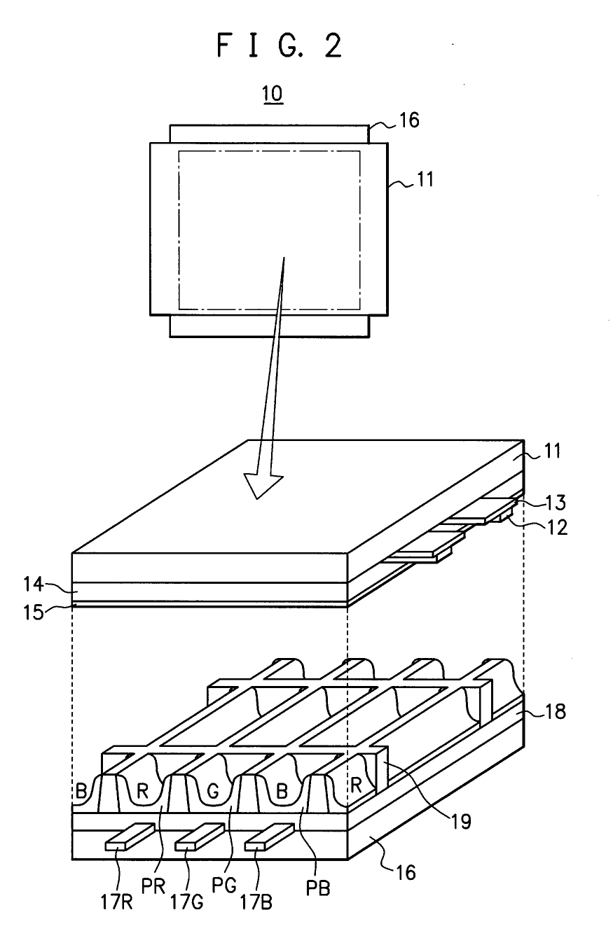

FIG. 2 is an exploded perspective view depicting a configuration example of the plasma display panel 10 in the present embodiment.

The display electrodes (also called as the sustain electrodes) constituted of a bus electrode (a metal electrode) 12 and a transparent electrode 13 are formed on a front glass substrate 11. The display electrodes (12, 13) correspond to the Y electrode Yi and the X electrode Xi depicted in FIG. 1. A dielectric layer 14 is provided on the display electrodes (12, 13), over the dielectric layer 14, an MgO (magnesium oxide) protective film 15 is further provided. Namely, the display electrodes (12, 13) disposed on the front glass substrate 11 are covered with the dielectric layer 14, and further a surface thereof is covered with the MgO protective film 15.

On a rear glass substrate 16 disposed opposite the front glass substrate 11, address electrodes 17R, 17G, and 17B are formed in a direction perpendicular to the display electrodes (12, 13) (in a manner to intersect therewith). The address electrodes 17R, 17G, and 17B correspond to the address electrodes Aj depicted in FIG. 1. A dielectric layer 18 is provided on the address electrodes 17R, 17G, and 17B.

Further, on the dielectric layer 18, a closed-type rib 19 disposed in a grid pattern, namely dividing a discharge space into each cell, and phosphor layers PR, PG, and PB emitting visible light in red (R), green (G), and blue (B) for a color display are formed. The phosphor layers PR, PG, and PB are excited by ultraviolet rays generated by a surface discharge between the paired display electrodes (12, 13), and the respective colors emit light.

The rib 19 is constituted of longitudinal ribs formed in an extending direction of the address electrodes 17R, 17G, and 17B, and transverse ribs formed in an extending direction of the display electrodes (12, 13). Namely, the plasma display panel 10 in the present embodiment has a closed-type rib structure.

Regarding the phosphor layers PR, PG, and PB, the phosphor layer PR emitting light in red is formed above the address electrode 17R, the phosphor layer PG emitting light in green is formed above the address electrode 17G, and the phosphor layer PB emitting light in blue is formed above the address electrode 17B. In other words, the address electrodes 17R, 17G, and 17B are disposed to correspond to the phosphor layers PR, PG, and PB in red, green, and blue coated on an inner surface of the rib 19 corresponding to the cells.

The plasma display panel 10 is constituted by sealing the front glass substrate 11 and the rear glass substrate 16 so that the MgO protective film 15 and the rib 19 are contacted, and sealing discharge gas such as Ne—Xe gas inside thereof (the discharge space between the front glass substrate 11 and the rear glass substrate 16).

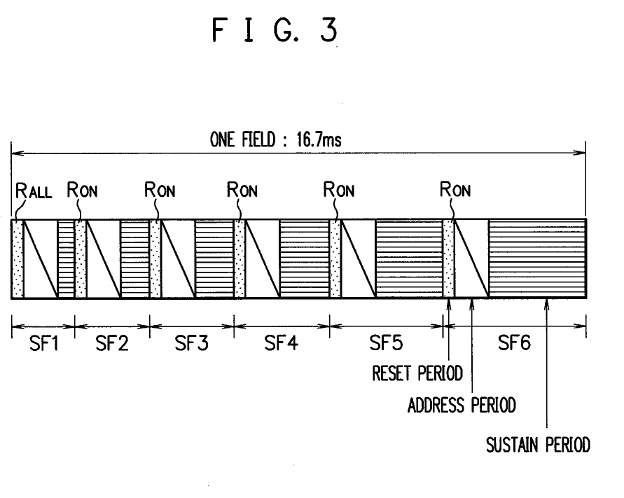

FIG. 3 is a view for explaining an example of the driving method of the plasma display device in the present embodiment. One field is constituted of a plurality of sub-fields (SFs). In FIG. 3, a constitution of which one field is composed of six sub-fields SF1, SF2, SF3, SF4, SF5, and SF6 is depicted as a matter of convenience for drawing, however a constitution of which one field is composed of 10 to 12 sub-fields is normal.

Each of the sub-fields SF1 to SF6 is constituted by the reset period, the address period, and the sustain period. In the reset period, the wall charge state on the electrode is initialized, and in the address period, the cells to be lighted are selected by adjusting the wall charge state in correspondence with the display data, and in the sustain period, the cells corresponding to the display data are lighted (the cells selected in accordance with the display data are discharge light emitted). The sub-fields SF1 to SF6 are weighted corresponding to a relative ratio of a luminance, and a gradation expression is realized by selecting at which of the sub-fields SF1 to SF6 the cell is lighted.

Further, in the reset period, an all-cell reset R_{ALL} of which a reset discharge is performed at all the cells of the display line, or an on-cell reset R_{ON} of which the reset discharge is performed at the cells lighted in the sustain period of the previous sub-field, namely only at the cells where the sustain discharge is performed, is performed. FIG. 3 depicts a case that the all-cell reset R_{ALL} is performed at a head sub-field, and the on-cell reset R_{ON} is performed at the sub-fields except the head sub-field as one example.

Note that the drive method depicted in FIG. 3 is one example, and not limited to this, and different methods are available. For example, in the present embodiment, the all-cell reset R_{ALL} is performed once in one field, however which is not limited to this.

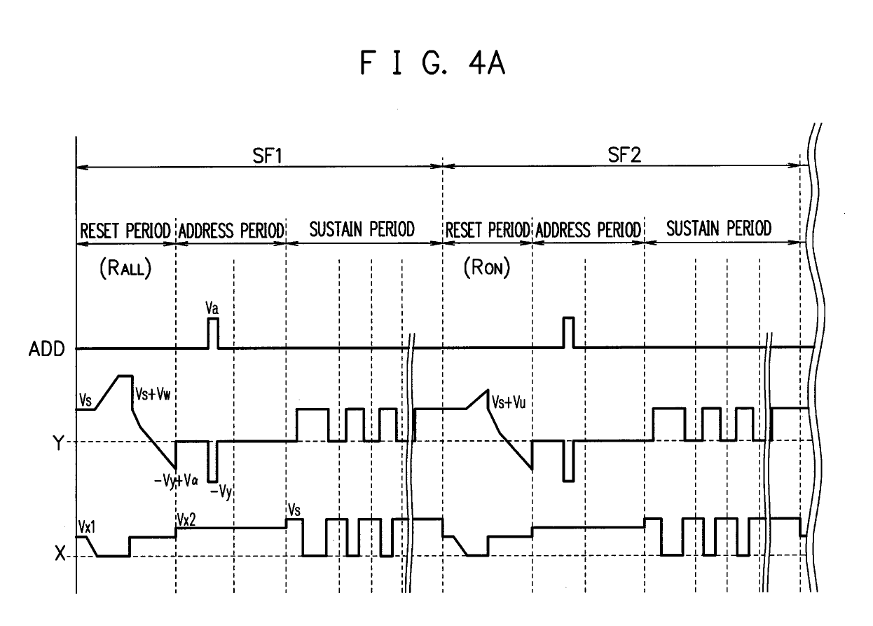

FIG. 4A and FIG. 4B are views depicting an example of a driving waveform of the plasma display device in the present embodiment. FIG. 4A depicts the driving waveforms at the first sub-field SF1 (the head sub-field) and the second sub-field SF2 in one field. FIG. 4B depicts the driving waveforms at the third sub-field SF3 and later continuing from FIG. 4A. In FIG. 4A and FIG. 4B, “ADD” depicts a voltage waveform related to the address electrode Aj, and “Y” depicts the voltage waveform related to the Y electrode Yi, and “X” depicts the voltage waveform related to the X electrode Xi.

In the reset period, initialization of the cell Cij is performed. In the reset period, a positive ramp wave is applied to the Y electrode Yi of the display line all at once to form the wall charge, and then a negative ramp wave is applied to the Y electrode Yi of the display line all at once to adjust an amount of the wall charge of the cell Cij. Specifically, as the positive ramp wave applied in the reset period, in the reset period of the head sub-field SF1, the all-cell reset R_{ALL} is performed to each display line by applying a reset pulse of an ultimate voltage (Vs+Vw) to the Y electrode Yi of the display line. Further, in each of the reset periods of the second sub-field SF2 and later, the on-cell reset R_{ON} is performed to each display line by applying the reset pulse of an ultimate voltage (Vs+Vu) (set as Vw>Vu) to the Y electrode Yi of the display line.

The positive ramp wave is a waveform having a positive ramp, and an applied voltage shifts to a positive direction continuously as time passes. And also, the negative ramp wave is a waveform having a negative ramp, and the applied voltage shifts to a negative direction continuously as time passes. A rate of shift of the applied voltage in the ramp wave can be constant, or change as time passes.

In the address period, a scan operation selecting either light emission (lighting) or non-light emission (non-lighting) of each cell Cij of the display line by an address designation based on the display data is performed. In the address period, the scan pulse is applied to the Y electrode Yi of the display line sequentially, and corresponding to the scan pulse, an address pulse is applied to the address electrode Aj. Thereby, a discharge is occurred between the Y electrode Yi and the address electrode Aj, and the wall charge is formed between the X electrode Xi and the Y electrode Yi by the discharge, and either light emission or non-light emission of the cell Cij is selected.

If the address pulse of the address electrode Aj is generated corresponding to the scan pulse of the Y electrode Yi, light emission of the cell Cij formed by the Y electrode Yi, the X electrode Xi, and the address electrode Aj is selected. Otherwise, if the address pulse of the address electrode Aj is not generated corresponding to the scan pulse of the Y electrode Yi, light emission of the cell Cij formed by the Y electrode Yi, the X electrode Xi, and the address electrode Aj is not selected, therefore, non-light emission is selected.

In the sustain period, the sustain pulse is applied to the X electrode Xi and the Y electrode Yi alternately, and the sustain discharge is performed between the X electrode Xi and the Y electrode Yi of the cell selected in the address period, and light emission is performed.

Here, the ultimate voltage (Vs+Vu) of the positive ramp wave (the reset pulse) applied at the on-cell reset R_{ON} is set as a voltage, as described above, smaller than the ultimate voltage (Vs+Vw) of the positive ramp wave (the reset pulse) applied at the all-cell reset R_{ALL}, and larger than a maximum voltage Vs of the sustain pulse. For example, in the present embodiment, Vw is set as 180V, and Vu is set as 40V, which is equal to or less than a half thereof.

More specifically, the voltage (Vs+Vu) is set as a voltage that makes a weak discharge occur at a cell where the wall discharge is decreased due to the adjacent cell being a lighting cell, and conventionally, the address discharge can not occur (an error occurs) among non-lighting cells in the sustain period of the preceding sub-field, and does not make a discharge occur at the non-lighting cell where the wall charge is not decreased (a normal non-lighting cell). In other words, the voltage (Vs+Vu) is set as a voltage such that a potential difference between the X electrode Xi and the Y electrode Yi (an absolute potential difference considering the stored wall charge) is larger than the maximum voltage Vs of the sustain pulse, and not above a discharge start voltage (a discharge start voltage in the case of all cells being a black display).

In the present embodiment as described above, the positive ramp wave (the reset pulse) of the ultimate voltage (Vs+Vu) is applied at the on-cell reset R_{ON}. Thereby, it makes it possible to return the wall charge to a normal state by making the weak discharge occur and storing the wall charge at the cell where it is non-lighting in the sustain period of the preceding sub-field, and the wall charge is decreased due to an influence from the adjacent cell. Further, at the cell lighted in the sustain period of the preceding sub-field as well, it makes it possible to make a state where the address discharge occurs easily by making the weak discharge occur and storing the wall charge reversed in the address period again.

Concretely, in the sustain period of the preceding sub-field, the non-lighting cell has a negative wall charge on the Y electrode Yi in a normal case (for example, the black display). Therefore even though the positive dull wave (the reset pulse) is applied to the Y electrode Yi, a discharge does not occur as long as being a wall voltage of which the negative wall charge is added to the applied voltage, and not being above the discharge start voltage between the X electrode Xi and the Y electrode Yi. In the sustain period of the preceding sub-field, at the cell being non-lighting, and of which the adjacent cell is lighted, a positive charge on the address electrode Aj and a negative charge on the Y electrode Yi are neutralized and eliminated, therefore, the applied voltage that starts the discharge with the positive ramp wave lowers. Accordingly, when the positive ramp wave of the ultimate voltage (Vs+Vu) that does not cause the discharge in the normal state is applied, the weak discharge occurs only at the cells where the wall charge is decreased due to the influence from the adjacent cell, and the like among the non-lighting cells in the sustain period of the preceding sub-field, which makes it possible to return the wall charge to the normal state.

Accordingly, at the following sub-field, it is possible to make the address discharge occur securely at the cell to be lighted based on the display data, and light the cell, and prevent an erroneous display. Note that the ramp wave of the ultimate voltage (Vs+Vu) applied at the on-cell reset R_{ON} does not cause the discharge at the normal non-lighting cell among the non-lighting cells in the sustain period of the preceding sub-field, therefore, the display quality also does not deteriorate without the background luminance becoming high.

And also, the ultimate voltage (Vs+Vu) of the positive ramp wave (the reset pulse) applied at the on-cell reset R_{ON} is changed in accordance with the reset voltage control information (for example, the number of the sustain pulses applied in the sustain period of the preceding sub-field, the address width in the address period (the scan pulse width), the ambient temperature, the cumulative operation time, and so on), which leads to improve the display quality further.

For example, in the case of changing the ultimate voltage (Vs+Vu) in accordance with the number of the sustain pulses at the preceding sub-field, when the wall charge (a wall potential) decreases by the sustain pulse, the ultimate voltage (Vs+Vu) of the positive ramp wave is raised, and the wall charge is stored more, thereby the discharge occurs easily, and an occurrence of erroneous light-off can be prevented. As one example, in the reset period of the sub-field, which is following after the sub-field of which the number of the sustain pulses to be applied is small, it is considered that the amount of the wall charge stored in the sustain period of the preceding sub-field is small and the discharge does not occur easily, therefore, the ultimate voltage (Vs+Vu) is to be raised.

In the case of changing the ultimate voltage (Vs+Vu) in accordance with the address width in the address period, when the address width is narrow, the address discharge does not occur easily, therefore the ultimate voltage (Vs+Vu) of the positive ramp wave is raised, and the wall charge is stored more, thereby, the discharge occurs easily, and the occurrence of erroneous light-off can be prevented.

In the case of changing the ultimate voltage (Vs+Vu) in accordance with the ambient temperature, a temperature detection is performed at a logic substrate, and the like in accordance with a temperature of the plasma display module (a temperature on a plane of the panel), thereby the ultimate voltage (Vs+Vu) is changed. For example, when the module temperature is low, the wall charge is decreased less, therefore, the ultimate voltage (Vs+Vu) of the positive ramp wave is lowered. On the other hand, when the module temperature is high, the wall charge is decreased more, therefore, the ultimate voltage (Vs+Vu) of the positive ramp wave is raised.

In the case of changing the ultimate voltage (Vs+Vu) in accordance with the cumulative operation time of the plasma display device, the cumulative operation time is measured at the logic substrate, and after a constant time passes, the ultimate voltage (Vs+Vu) of the positive ramp wave is raised. This is because keeping the panel light emitted causes a deterioration of the MgO protective film used in the panel, thereby the discharge does not occur easily (it is concerned that the wall charge is decreased).

Hereinafter, a control method of the positive ramp wave (the reset pulse) applied at the on-cell reset R_{ON} will be explained.

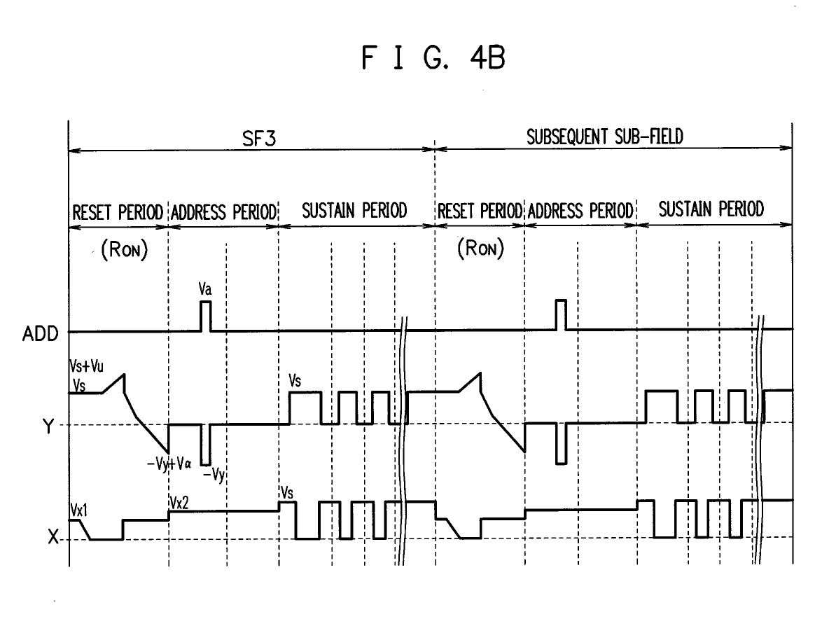

FIG. 5A is a view depicting a configuration example of the reset circuit 23. In FIG. 5A, one end of a switch SWA is coupled to a reset voltage Vw′ of the positive ramp wave applied at the all-cell rest R_{ALL}, and the other end of the switch SWA is coupled to the plasma display panel 10 via the scan circuit 21.

The reset circuit 23 is configured as depicted in FIG. 5A so that the time when placing the switch SWA in an on state (a continuity state) is controlled without changing the ramp of the positive ramp wave as depicted in FIG. 5B, and therefore, the ultimate voltage (Vs+Vu) can be changed. For example, as depicted in FIG. 5B, the time when the switch is in the on state is extended from t1 to t2, thereby the ultimate voltage (Vs+Vu) can be raised from Vu1 to Vu2. Further, the positive ramp wave at the on-cell reset R_{ON} can be applied at the same circuit as the circuit for which the positive ramp wave is applied at the all-cell reset R_{ALL} without increasing the number of circuits and a cost.

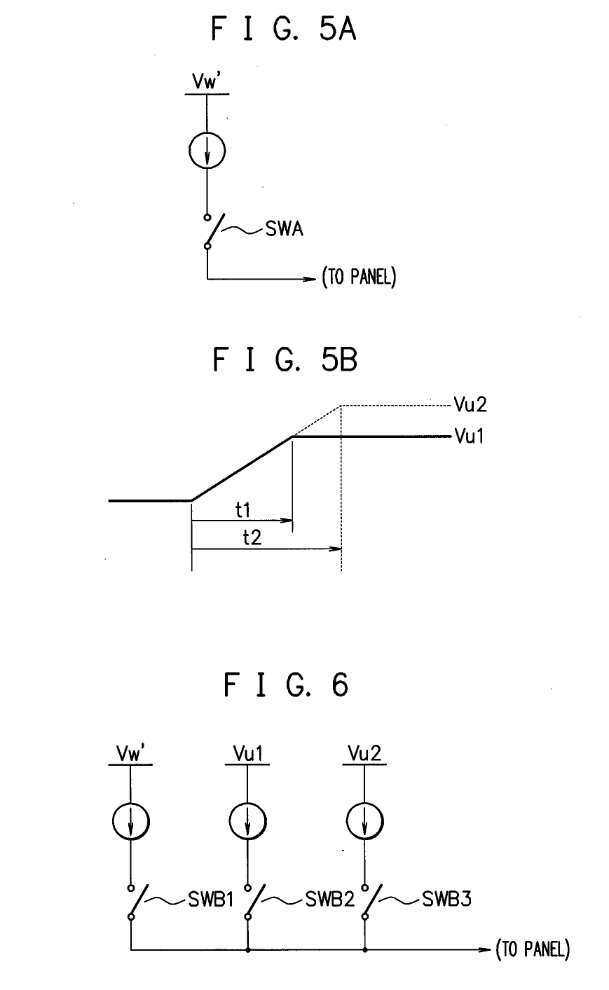

Also, as depicted in FIG. 6, the reset circuit 23 can be configured such that switches SWB1, SWB2, and SWB3 are coupled to respective reset voltages to which the positive ramp wave is applied. In FIG. 6, one end of the switch SWB1 is coupled to the reset voltage Vw′ of the positive ramp wave applied at the all-cell reset R_{ALL}, and one end of the switch SWB2 is coupled to a reset voltage Vu1 of the positive ramp wave applied at the on-cell reset R_{ON}, and one end of the switch SWB3 is coupled to a reset voltage Vu2 (Vu2≠Vu1) of the positive ramp wave applied at the on-cell reset R_{ON}. The other ends of the switches SWB1, SWB2, and SWB3 are coupled to the plasma display panel 10 via the scan circuit 21. It makes it possible to change the voltage to which the positive ramp wave is applied by changing the switch that is placed in the on state in the reset period.

In the explanation described above, it is constituted that the time when the switch in the reset circuit is placed in the on state is controlled, thereby, the ultimate voltage of the positive ramp wave (the reset pulse) is controlled. However it can be constituted such that an applied voltage is detected by the positive ramp wave and the switch in the reset circuit is on/off controlled in accordance with the detected voltage. When it is constituted that an applied voltage is detected and the switch in the reset circuit is on/off controlled, it is possible to realize a secure control of the ultimate voltage of the positive ramp wave (the reset pulse) without influences of a variation in a panel capacitance of the plasma display panel, and the like.

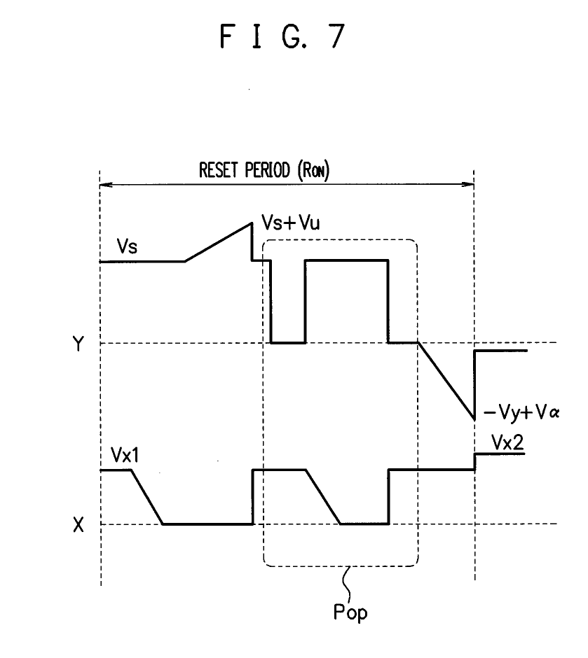

Further, it is constituted that after the positive ramp wave of the ultimate voltage (Vs+Vu) is applied to the Y electrode Yi of the display line all at once, the negative ramp wave of an ultimate voltage (−Vy+Vα) is applied to the Y electrode Yi of the display line all at once at the on-cell reset R_{ON}. However, as depicted in FIG. 7, it can be constituted such that after the positive ramp wave of the ultimate voltage (Vs+Vu) is applied, and before the negative ramp wave of the ultimate voltage (−Vy+Vα) is applied, an option pulse P_{OP} is added so as to be applied. In the case constituted in this manner, even when applying the positive ramp wave of the ultimate voltage (Vs+Vu) causes not a weak discharge but a strong discharge depending on a storage state of the wall charge, the discharge by the applied option pulse P_{OP} returns the wall charge to the normal state, therefore, it makes it possible to prevent the erroneous display such as the erroneous light-off from occurring.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A driving method of a plasma display device, wherein
one field is constituted with a plurality of sub-fields, and each sub-field has an address period in which selection of the cell to be lighted is performed in correspondence with the display data and a sustain period in which the cell selected in the address period is made to perform discharge light emission, further
each sub-field has a reset period in which a reset discharge initializing a wall charge state on an electrode is performed,
wherein the reset period includes a first reset of which the reset discharge is performed at all cells, or a second reset of which the reset discharge is performed at some cells including a lighting cell at a previous sub-field is performed, and wherein
when the second reset is performed, a positive second ramp wave of an ultimate voltage, which is larger than a maximum voltage of a sustain pulse applied to a display electrode in the sustain period, and smaller than an ultimate voltage of a positive first ramp wave applied to the display electrode when the first reset is performed, is applied to the display electrode.

2. The driving method of the plasma display device according to claim 1, wherein
the ultimate voltage of the second ramp wave is (Vs+Vu),and the maximum voltage of the sustain pulse is Vs, the ultimate voltage of the first ramp wave is (Vs+Vw), and it is 0<Vu<(Vw/2).

3. A driving method of a plasma display device wherein
one field is constituted with a plurality of sub-fields, and each sub-field has an address period in which selection of the cell to be lighted is performed in correspondence with the display data and a sustain period in which the cell selected in the address period is made to perform discharge light emission, further
each sub-field has a reset period in which a reset discharge initializing a wall charge state on an electrode is performed, wherein the reset period includes a first reset of which the reset discharge is performed at all cells, or a second reset of which the reset discharge is performed at some cells including a lighting cell at a previous sub-field is performed, and wherein
when the second reset is performed, a positive second ramp wave of an ultimate voltage, which is larger than a maximum voltage of a sustain pulse applied to a display electrode in the sustain period, and of which a voltage of a second ramp wave to which the stored wall charge is added is not above a discharge start voltage of between the display electrodes, is applied to the display electrode.

4. The driving method of the plasma display device according to claim 1, wherein
the ultimate voltage of the second ramp wave is changeable.

5. The driving method of the plasma display device according to claim 3, wherein
the ultimate voltage of the second ramp wave is changeable.

6. The driving method of the plasma display device according to claim 4, wherein
the ultimate voltage of the second ramp wave is changed in accordance with at least one piece of information among the number of sustain pulses applied at a previous sub-field, a width of a scan pulse applied in an address period, an ambient temperature, and a cumulative operation time.

7. The driving method of the plasma display device according to claim 5, wherein
the ultimate voltage of the second ramp wave is changed in accordance with at least one piece of information among the number of sustain pulses applied at a previous sub-field, a width of a scan pulse applied in an address period, an ambient temperature, and a cumulative operation time.

8. A plasma display device, wherein one field is constituted with a plurality of sub-fields, and each sub-field has an address period in which selection of the cell to be lighted is performed in correspondence with the display data and a sustain period in which the cell selected in the address period is made to perform discharge light emission, further each sub-field has a reset period in which a reset discharge initializing a wall charge state on an electrode is performed, the plasma display device comprising:
a reset unit selecting and performing either a first rest of which the reset discharge is performed at all cells, or a second reset of which the reset discharge is performed at some cells including a lighting cell at a previous sub-field in a reset period, and wherein
when the second reset is performed, the reset unit applies a positive second ramp wave of an ultimate voltage, which is larger than a maximum voltage of a sustain pulse applied to a display electrode in the sustain period, and smaller than an ultimate voltage of a positive first ramp wave applied to the display electrode when the first reset is performed, to the display electrode.

9. The plasma display device according to claim 8, wherein
the reset unit has a switch of which one end is coupled to a voltage of a first ramp wave applied at the first reset and the other end is coupled to a display electrode, and
the first ramp wave and the second ramp wave are applied to the display electrode by controlling a time when placing the switch in an on state.

10. The plasma display device according to claim 8, wherein
the reset unit has a first switch of which one end is coupled to the first voltage and the other end is coupled to a display electrode, and a second switch of which one end is coupled to a second voltage different from the first voltage and the other end is coupled to the display electrode, and wherein
the first ramp wave is applied to the display electrode by placing the first switch in an on state, and the second ramp wave is applied to the display electrode by placing the second switch in the on state.

11. The plasma display device according to claim 8 further comprising:
a reset setting unit setting the ultimate voltage of the second ramp wave in accordance with at least one piece of information among the number of sustain pulses applied at a previous sub-field, a width of a scan pulse applied in an address period, an ambient temperature, and a cumulative operation time.

12. The plasma display device according to claim 9, further comprising:
a reset setting unit setting the ultimate voltage of the second ramp wave in accordance with at least one piece of information among the number of sustain pulses applied at a previous sub-field, a width of a scan pulse applied in an address period, an ambient temperature, and a cumulative operation time.

13. The plasma display device according to claim further comprising:
a reset setting unit setting the ultimate voltage of the second ramp wave in accordance with at least one piece of information among the number of sustain pulses applied at a previous sub-field, a width of a scan pulse applied in an address period, an ambient temperature, and a cumulative operation time.
